(19) United States
(12) Patent Application Publication
(10) Pub. No.: US 2026/0093160 A1
(43) Pub. Date: Apr. 2, 2026

(54) MULTI-GEAR CONTROL MECHANISM

(71) Applicant: TILTA INC., Burbank, CA (US)

(72) Inventors: Long MA, Shenzhen (CN); Yaolong LUO, Shenzhen (CN); Wenping ZENG, Shenzhen (CN); Kefeng ZHOU, Shenzhen (CN)

(21) Appl. No.: 19/332,626

(22) Filed: Sep. 18, 2025

(30) Foreign Application Priority Data
Sep. 30, 2024 (CN) 2024224166101

(51) Int. Cl. G03B 13/34; G03B 3/10; G03B 17/56

(52) U.S. Cl. CPC G03B 13/34; G03B 3/10; G03B 17/563

(57) ABSTRACT

A multi-gear control mechanism includes: a housing provided with a first limit protrusion; a toggle member rotatably connected to the housing and having a second limit protrusion; a travel space defined between the housing and the toggle member, wherein both the first and the second limit protrusions are located within the travel space; a gear adjustment switch having a travel limiter configured to move into and out of the travel space; and a sensor. The gear adjustment switch moves relative to the sensor and the toggle member, thereby enabling or disabling signal transmission from the sensor, and causing the travel limiter to enter or exit the travel space. This configuration adjusts the travel range of the toggle member, resulting in different travel ranges between the first and the second limit protrusions, thereby achieving multi-gear switching with varying travels and facilitating parameter adjustment.

### CROSS-REFERENCE TO RELATED APPLICATIONS

The present application for patent claims priority to and the benefit of pending Chinese Application No. 2024224166101, which is filed on September 30, 2024, and hereby expressly incorporated by reference herein as if fully set forth below in its entirety and for all applicable purposes.

### TECHNICAL FIELD

The present disclosure pertains to the field of shooting assistance equipment, especially to a multi-gear control mechanism.

### INTRODUCTION

In shooting, users often require different lens parameters (e.g., zoom, focus, aperture) to achieve different compositions and effects, necessitating adjustments through lens rotation. To facilitate such adjustments, follow focus devices, such as follow focus handles, have been introduced. These handles typically include a thumb wheel (operating component). When the user rotates the thumb wheel, the handle’s processor generates corresponding signals to control lens parameter adjustments. However, existing thumb wheels offer limited adjustment modes and lack the ability to switch among multiple gears, resulting in operational inconvenience.

### BRIEF SUMMARY

To address the aforementioned limitations, the present disclosure provides a multi-gear control mechanism that enables switching among multiple travel ranges via different gears, thereby facilitating parameter adjustment and improving overall usability.

Aspects of the present disclosure provide a multi-gear control mechanism, including:

a housing provided with a first limit protrusion;

a toggle member rotatably connected to the housing and provided with a second limit protrusion, wherein a travel space is defined between the housing and the toggle member, and both the first and second limit protrusions are located within the travel space;

a gear adjustment switch disposed on the housing and provided with a travel limiter, wherein the travel limiter is configured to move into and out of the travel space;

the gear adjustment switch is movable relative to the housing, causing the travel limiter to enter or exit the travel space, thereby adjusting the travel range of the toggle member for gear switching.

The present disclosure incorporates a travel limiter on the gear adjustment switch. Movement of the gear adjustment switch drives the travel limiter into or out of the travel space. When the travel limiter enters the travel space, the travel limiter and the first limit protrusion jointly constrain the movement of the second limit protrusion on the toggle member. When the travel limiter exits the travel space, it ceases to constrain the second limit protrusion, leaving only the first limit protrusion to provide limitation. In summary, by adjusting the travel range of the toggle member via the gear adjustment switch, multi-gear control with varying travel ranges is achieved, facilitating parameter adjustment and improving usability.

### BRIEF DESCRIPTION OF THE DRAWINGS

FIG. 1 is a diagram illustrating a follow focus handle according to some aspects of the disclosure.

FIG. 2 is a diagram illustrating the follow focus handle of FIG. 1 with a toggle member omitted according to some aspects of the disclosure.

FIG. 3 is a cross-sectional view of the follow focus handle according to some aspects of the disclosure.

FIG. 4 is a diagram illustrating a gear adjustment part of the follow focus handle according to some aspects of the disclosure.

FIG. 5 is an exploded view of the gear adjustment part of FIG. 4 according to some aspects of the disclosure.

FIG. 6 is a bottom view of a toggle member according to some aspects of the disclosure.

FIG. 7 is a diagram illustrating a gear adjustment component according to some aspects of the disclosure.

FIG. 8 is a cross-sectional view of the follow focus handle with the gear adjustment part in the first gear according to some aspects of the disclosure.

FIG. 9 is a cross-sectional view of the follow focus handle with the gear adjustment part in the second gear according to some aspects of the disclosure.

FIG. 10 is a cross-sectional view of the follow focus handle with the gear adjustment part in the third gear according to some aspects of the disclosure.

Reference Numerals: 1. follow focus handle; 11. main body; 12. mounting position; 13. main control PCBA; 2. multi-gear control mechanism; 21. control circuit board; 22. magnetic member; 23. housing; 231. first limit protrusion; 2311. rotation limit ring; 2312. movement groove; 2316. elastic member; 232. toggle member; 2321. thumb wheel; 2322. rotation limit groove; 233. second limit protrusion; 235. travel space; 2351. first travel space; 2352. second travel space; 236. rotating shaft; 237. bearing; 238. gear adjustment switch; 2381. travel limiter; 2382. signal blocker; 2383. gear adjustment component; 2384. gear positioning part; 2385. gear positioning component; 2386. gear positioning area; 239. sensor; 24. magnetic encoder; 3. detection module.

### DETAILED DESCRIPTION

To further illustrate the various aspects of the disclosure, the following description is provided with reference to the accompanying drawings and illustrative examples. It should be understood that the specific embodiments described herein are provided for the purpose of illustration and not intended to limit the scope of the present disclosure.

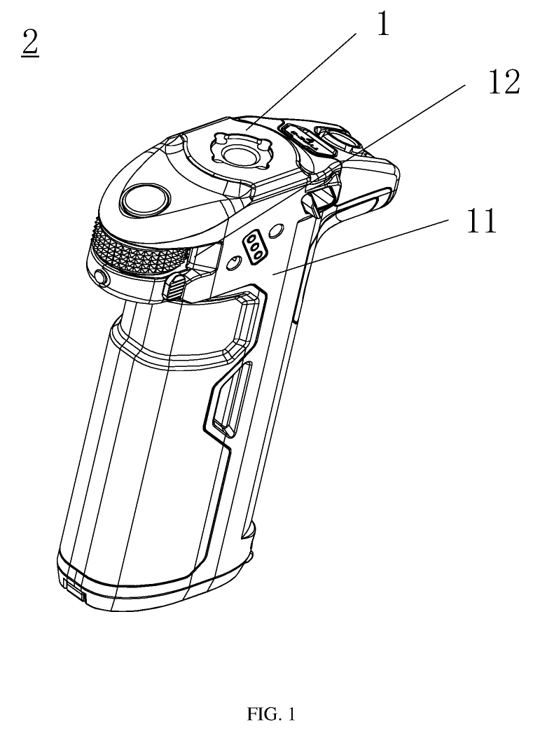

Referring to FIGS. 1-10, aspects of the disclosure provide a multi-gear control mechanism 2, which may be implemented as a multi-gear follow focus handle 1. When connected to photographic equipment, the follow focus handle 1 enables multi-gear adjustment of parameters such as focus, aperture, and focal length.

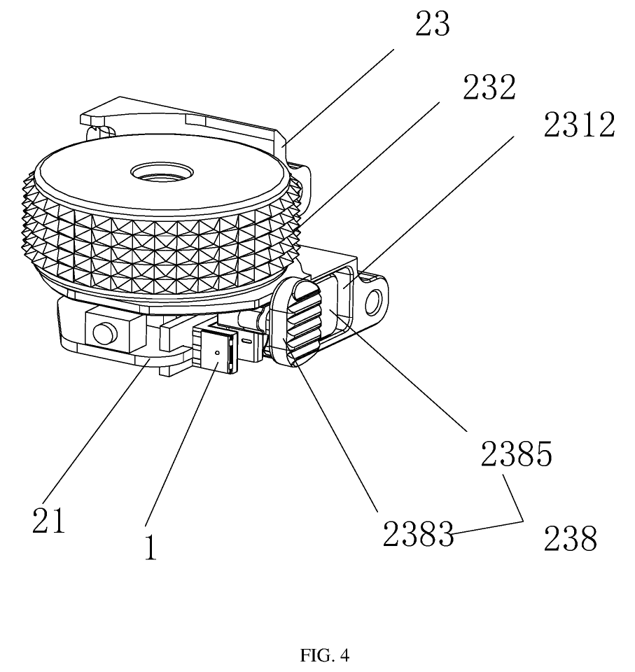

As shown in FIG. 1, the main body 11 of the follow focus handle 1 includes a mounting position 12. A toggle member 232 (e.g., see FIG. 4) of the follow focus handle 1 is disposed at the mounting position 12, connected to a main control PCBA 13 (e.g., see FIGS. 8-10; PCBA, which stands for Printed Circuit Board Assembly, is the fully assembled version of a PCB (Printed Circuit Board) with all electronic components mounted and soldered onto it. This PCBA transforms a simple bare board into a functional electronic circuit capable of powering devices ranging from smartphones to industrial machinery) of the follow focus handle 1, and can be at least partially exposed outside the main body 11. This configuration allows a multi-gear control mechanism 2 to be easily operated from outside the main body 11 to adjust focus parameters of the photographic equipment.

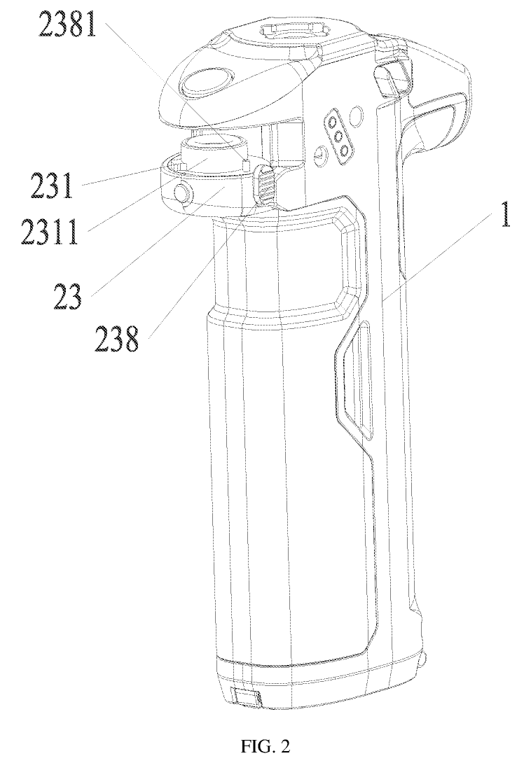

Referring to FIGS. 2-4, in some aspects, the multi-gear control mechanism 2 includes a housing 23, a toggle member 232, and a gear adjustment switch 238. The housing 23 is provided with a first limit protrusion 231.

The toggle member 232 is rotatably connected to the housing 23 and is provided with a second limit protrusion 233. A travel space 235 is defined between the housing 23 and the toggle member 232. Both the first limit protrusion 231 and the second limit protrusion 233 are located within the travel space 235.

The gear adjustment switch 238 is disposed on the housing 23 and is provided with a travel limiter 2381. The travel limiter 2381 is configured to move into and out of the travel space 235. The housing 23 may include an elongated hole (e.g., slot) to allow the gear adjustment switch 238 to move relative to the housing 23, enabling the travel limiter 2381 to enter or exit the travel space 235 and thereby adjust the travel range of the toggle member 232.

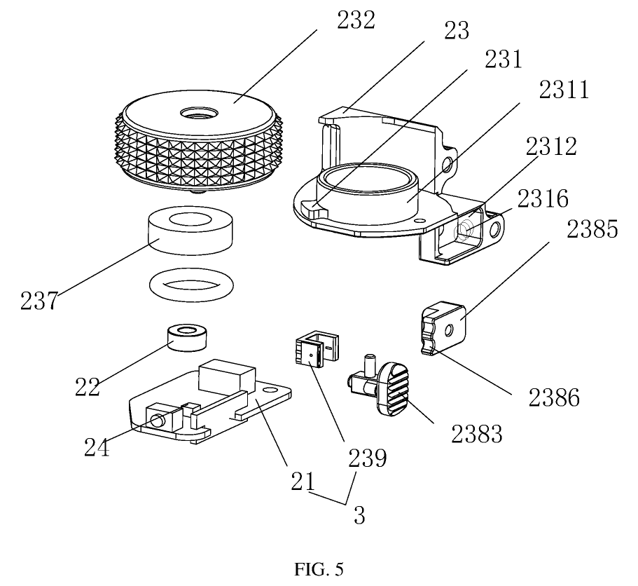

In some aspects, the multi-gear control mechanism 2 includes a control circuit board 21 and a magnetic member 22 (e.g., see FIG. 5).

In some aspects, referring to FIGS. 2-4, the toggle member 232 is rotatably connected to the housing 23. The control circuit board 21 is fixed to the housing 23, and the magnetic member 22 is fixed to the toggle member 232. The control circuit board 21 is equipped with a magnetic encoder 24 that cooperates or interacts with the magnetic member 22. The magnetic encoder 24 and the magnetic member 22 are arranged opposite each other.

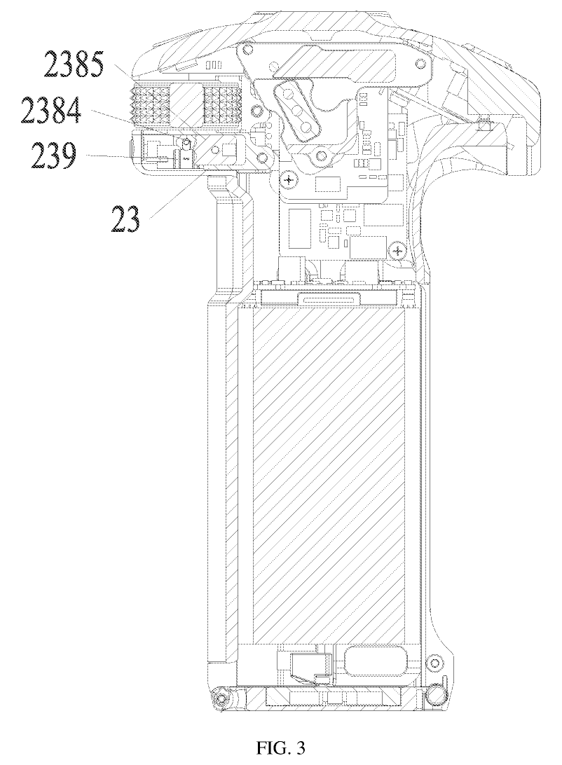

In some aspects, referring to FIG. 3, the magnetic member 22 is a magnet. Rotating the toggle member 232 (e.g., see FIG. 4) outside the main body 11 of the follow focus handle 1 drives the magnet to rotate relative to the magnetic encoder 24. The control circuit board 21 detects the rotation angle of the magnet via the magnetic encoder 24, thereby obtaining the adjustment angle of the toggle member 232. This angle is fed back to the main control PCBA 13 of the follow focus handle 1 via the control circuit board 21. The main control PCBA 13 then issues corresponding control commands to adjust parameters such as the focus of the photographic equipment.

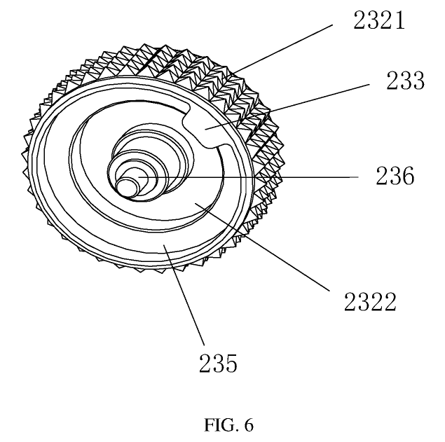

In some aspects, referring to FIGS. 5-6, the housing 23 is provided with a first limit protrusion 231, and the toggle member 232 is provided with a second limit protrusion 233. A travel space 235 is defined between the housing 23 and the toggle member 232. Both the second limit protrusion 233 and the first limit protrusion 231 are located within the travel space 235 and interfere structurally when they contact each other. The toggle member 232 is rotatably connected to the housing 23, allowing a travel range between the second limit protrusion 233 and the first limit protrusion 231. Rotating the toggle member 232 drives the second limit protrusion 233 toward the first limit protrusion 231. The maximum rotational distance between them defines the maximum travel range of the toggle member 232.

In some aspects, the toggle member 232 includes a thumb wheel 2321 with a rotation limit groove 2322. The housing 23 is provided with a rotation limit ring 2311 that fits to the rotation limit groove 2322. The second limit protrusion 233 is located on the side wall of the rotation limit groove 2322, and the first limit protrusion 231 is located on the outer wall of the rotation limit ring 2311. When the thumb wheel 2321, which is partially outside the main body 11 of the follow focus handle 1, is rotated, it drives the second limit protrusion 233 to rotate relative to the first limit protrusion 231, the rotation limit ring 2311 and the rotation limit groove 2322 cooperate or interact to provide constraint, enhancing structural stability.

In some aspects, the rotation limit groove 2322 contains a rotating shaft 236. The magnetic member 22 is mounted on the rotating shaft 236, and a bearing 237 is provided between the rotating shaft 236 and the rotation limit ring 2311. This configuration ensures that rotating the thumb wheel 2321 drives the magnetic member 22 to rotate, synchronizing the movement of the magnetic member 22 with the second limit protrusion 233 and facilitating the detection of the parameter adjustment angle. The bearing 237 enhances structural stability.

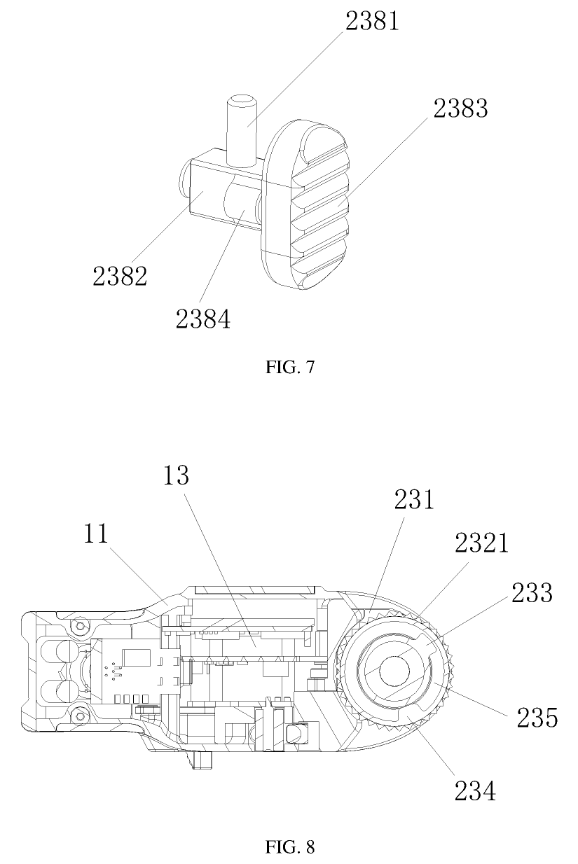

In some aspects, referring to FIG. 7, the multi-gear control mechanism 2 includes a gear adjustment switch 238 and a sensor 239. The sensor 239 is electrically connected to the control circuit board 21 to form a detection module 3. The gear adjustment switch 238 includes a travel limiter 2381. The gear adjustment switch 238 is movable relative to the sensor 239 and the toggle member 232, thereby enabling or disabling signal transmission from the sensor 239. This information is fed back to the control circuit board 21, providing information on the current gear state of the toggle member 232. Simultaneously, movement of the gear adjustment switch 238 causes the travel limiter 2381 to enter or exit the travel space 235, adjusting the travel range of the toggle member 232. The cooperation or interaction between the sensor 239 and the travel limiter 2381 enables gear switching.

In some aspects, when the travel limiter 2381 extends into the travel space 235, it divides the travel space 235 into a first travel space 2351 and a second travel space 2352. The first limit protrusion 231 can be located in either the first travel space 2351 or the second travel space 2352 to form different gears.

In some aspects, the gear adjustment switch 238 is configured to move vertically and has two control positions for gear switching: a first position and a second position. When the gear adjustment switch 238 is moved to the first position, it blocks the signal transmission of the sensor 239, and its travel limiter 2381 disengages from the travel space 235. When the gear adjustment switch 238 is moved to the second position, it moves away from the sensor 239, allowing unimpeded signal transmission by the sensor 239. Simultaneously, the travel limiter 2381 enters the travel space 235 and structurally interferes with the second limit protrusion 233, thereby limiting the movement of the second limit protrusion 233 within the travel space 235 and adjusting the travel of the toggle member 232.

In some aspects, the sensor 239 may be implemented as a through-beam photoelectric switch, a reflective photoelectric switch, or a proximity switch. Each of these includes a transmitter end and a receiver end, with a gap between them forming a signal transmission channel. When a foreign object enters this channel, the signal transmission is blocked, preventing communication between the transmitter and receiver. The signal transmission status of the sensor 239 is detectable by the control circuit board 21, thereby determining the position of the travel limiter 2381.

In some aspects, the gear adjustment switch 238 includes a gear adjustment component 2383 and a gear positioning component 2385. The gear adjustment component 2383 is movable relative to the sensor 239 and the toggle member 232. The gear adjustment component 2383 includes a signal blocker 2382 and a gear positioning part 2384. The signal blocker 2382 and the gear positioning part 2384 can be fixedly connected to the travel limiter 2381. The signal blocker 2382 is movable relative to the signal transmission channel, and the gear adjustment component 2383 is exposed outside the housing 23.

In some aspects, when using the multi-gear control mechanism 2 to adjust lens parameters, the user can control three gears via the mechanism, enabling switching among three different travels of the second limit protrusion 233.

Referring to FIG. 8, when the gear adjustment component 2383 is moved to the first position, the signal blocker 2382 enters the signal transmission channel, blocking signal transmission between the transmitter and receiver of the sensor 239. Consequently, the signal transmission of the sensor 239 is interrupted. Simultaneously, the travel limiter 2381 disengages from the travel space 235. The second limit protrusion 233 can then move unobstructed from one end of the first limit protrusion 231 to the other, achieving the maximum travel. At the software level, when the signal transmission channel is blocked, a processor (e.g., microcontroller) can detect the status of the sensor 239, thereby determining that the travel of the toggle member 232 is at its maximum, corresponding to the first gear.

When the gear adjustment component 2383 is moved to the second position, the signal blocker 2382 exits the signal transmission channel, allowing unimpeded signal transmission between the transmitter and receiver of the sensor 239. The processor can detect the status of the sensor 239 and obtain the current angle of the thumb wheel 2321 via the magnetic encoder 24. Simultaneously, the travel limiter 2381 enters the travel space 235 and interferes with the movement of the second limit protrusion 233, thereby restricting its travel. The second limit protrusion 233 cannot move freely from one end of the first limit protrusion 231 to the other, resulting in a different gear travel. It should be noted that when the gear adjustment component 2383 is moved to the second position, the following two scenarios may occur:

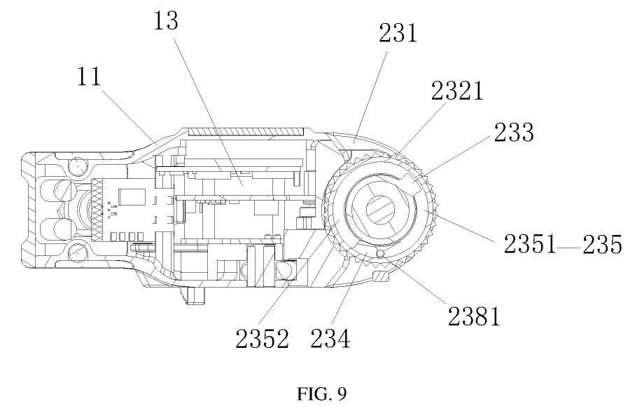

1. Referring to FIG. 9, when the gear adjustment component 2383 is in the second position and the travel limiter 2381 has entered the travel space 235, if the second limit protrusion 233 is located on the left side of the travel limiter 2381, it can only move between the travel limiter 2381 and the first limit protrusion 231 on the left side. This corresponds to the second gear.

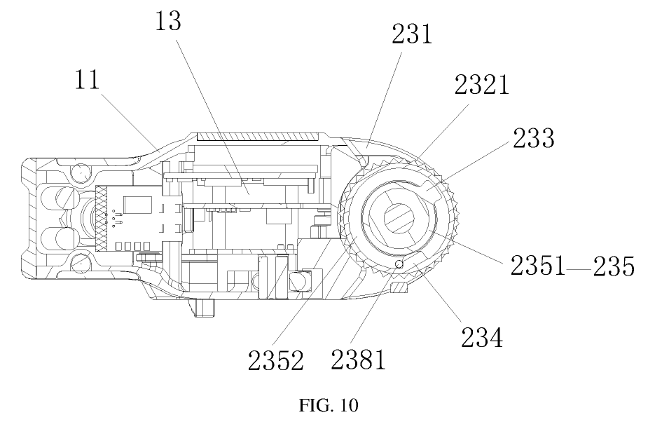

2. Referring to FIG. 10, when the gear adjustment component 2383 is in the second position and the travel limiter 2381 has entered the travel space 235, if the second limit protrusion 233 is located on the right side of the travel limiter 2381, it can only move between the travel limiter 2381 and the first limit protrusion 231 on the right side. This corresponds to the third gear.

In some aspects, at the software level, the travel origin of the second limit protrusion 233 can be calibrated. The processor is aware of the original position of the second limit protrusion 233 and obtains its rotational angle via the magnetic encoder 24, thereby identifying the rotational angle of the thumb wheel 2321. Since the angular ranges relative to the origin for the second and the third gears are distinct and non-overlapping, the processor can determine which gear the thumb wheel 2321 is in based on the real-time position of the second limit protrusion 233.

In some aspects, referring to FIG. 7, the gear adjustment component 2383 includes a gear positioning part 2384. The housing 23 has a movement groove 2312, within which a gear positioning component 2385 is movably disposed. The gear positioning component 2385 has two gear positioning areas 2386 that correspond to the gear positioning part 2384. These two gear positioning areas 2386 are vertically adjacent to each other. The gear positioning part 2384 can engage with either of these gear positioning areas 2386. When the gear adjustment component 2383 moves, it actuates the gear positioning component 2385, enabling the gear positioning part to switch between the two gear positioning areas 2386, thereby securing the gear adjustment component 2383 in different gear positions. In some aspects, when the gear adjustment component 2383 is in the first position, it moves to the lowermost position, and the gear positioning part 2384 engages within the lower gear positioning area 2386. When the gear adjustment component 2383 is in the second position, it is moved to the uppermost position, and the gear positioning part 2384 engages within the upper gear positioning area 2386. This ensures that the gear adjustment component 2383 is fixed and limited in each of the three gear positions.

In some aspects, the gear positioning part 2384 is an arc-shaped protrusion, and the gear positioning area 2386 is an arc-shaped groove that matches the arc-shaped protrusion. The complementary arc-shaped structures prevent the gear positioning part 2384 from becoming completely stuck in the gear positioning area 2386, facilitating smooth switching between the two gear positioning areas 2386.

In some aspects, an elastic member 2316 is provided within the movement groove 2312 to reset the gear positioning component 2385. One end of the elastic member 2316 can be connected (e.g., abutted) to the side wall of the movement groove 2312, while the other end can be connected (e.g., abutted) to the gear positioning component 2385. During the vertical movement of the gear adjustment component 2383 to switch between different gear positioning areas 2386, the gear positioning component 2385 is actuated to move within the movement groove 2312. The elastic member 2316 assists in resetting the gear positioning component 2385 through elastic force, ensuring secure engagement between the gear positioning part 2384 and the gear positioning area 2386.

In this disclosure, directional terms such as “upper,” “lower,” “front,” “rear,” “left,” “right,” and similar expressions are used for convenience of description only and are not intended to be limiting as to orientation or position of the components. The singular forms “a,” “an,” and “the” include plural referents unless the context clearly dictates otherwise. The terms “coupled,” “connected,” and “engaged” are used broadly to encompass both direct and indirect connections, whether mechanical, magnetic, or otherwise, unless specifically stated otherwise.

What is claimed is:

1. A multi-gear control mechanism, comprising:
a housing, provided with a first limit protrusion;
a toggle member, wherein the toggle member is rotatably connected to the housing and is provided with a second limit protrusion;
wherein a travel space is formed between the housing and the toggle member, and both the first limit protrusion and the second limit protrusion are located in the travel space;
a gear adjustment switch, disposed on the housing and provided with a travel limiter, wherein the travel limiter is movably extendable into and retractable from the travel space; and
wherein the gear adjustment switch is movable relative to the housing to enable the travel limiter to enter or disengage from the travel space, thereby adjusting a travel range of the toggle member.

2. The multi-gear control mechanism according to claim 1, wherein in response to the travel limiter extending into the travel space, the travel space is divided into a first travel space and a second travel space, and the second limit protrusion is provided in the first travel space or the second travel space to form different gears.

3. The multi-gear control mechanism according to claim 2, further comprising a detection module, wherein the detection module comprises a control circuit board and a sensor, and the sensor is electrically connected to the control circuit board; and
wherein in response to the gear adjustment switch moving to a first position, signal transmission of the sensor is blocked, and in response to the gear adjustment switch moving to a second position, signal transmission of the sensor is conducted.

4. The multi-gear control mechanism according to claim 3, wherein the gear adjustment switch further comprises a signal blocker, the sensor provides a signal transmission channel, and the signal blocker is movable with respect to the signal transmission channel;
wherein in response to the gear adjustment switch moving to the first position, the signal blocker enters the signal transmission channel to block signal transmission of the sensor; and
wherein in response to the gear adjustment switch moving to the second position, the signal blocker disengages from the signal transmission channel to enable signal transmission of the sensor.

5. The multi-gear control mechanism according to claim 1, wherein the gear adjustment switch comprises a gear adjustment component and a gear positioning component, the travel limiter is disposed on the gear adjustment component, and the gear positioning component is provided with multiple gear positioning areas; and
wherein the gear adjustment component comprises a gear positioning part, and the gear positioning part is switchable among the gear positioning areas and engageable with one of the gear positioning areas, enabling the gear adjustment component to control multi-gear adjustment.

6. The multi-gear control mechanism according to claim 5, wherein the gear positioning component is elastically connected to the housing, enabling the gear positioning component to move with respect to the housing to facilitate switching of the gear positioning part among the gear positioning areas.

7. The multi-gear control mechanism according to claim 5, wherein the gear positioning part comprises an arc-shaped protrusion, and the gear positioning area is configured as an arc-shaped groove adapted to receive the arc-shaped protrusion.

8. The multi-gear control mechanism according to claim 5, wherein the housing is provided with a movement groove, the gear positioning component is movably disposed in the movement groove, and the movement groove is provided with a elastic member; and
wherein one end of the elastic member abuts against or is connected to a side wall of the movement groove, and another end of the elastic member abuts against or is connected to the gear positioning component.

9. The multi-gear control mechanism according to claim 1, wherein the toggle member comprises a thumb wheel, the thumb wheel is provided with a rotation limit groove internally, and the housing is provided with a rotation limit ring adapted to be received in the rotation limit groove; and
wherein the first limit protrusion is located on a side wall of the rotation limit groove, and the second limit protrusion is located on an outer wall of the rotation limit ring.

10. The multi-gear control mechanism according to claim 9, further comprising:
a detection module, wherein the detection module comprises a control circuit board; and
a magnetic member, wherein the control circuit board is fixed to the housing, the magnetic member is fixed to the toggle member, and the control circuit board is provided with a magnetic encoder cooperating with the magnetic member; and
wherein the magnetic encoder is arranged opposite to the magnetic member.
